(19) United States
(12) Patent Application Publication
(10) Pub. No.: US 2018/0244572 A1
(43) Pub. Date: Aug. 30, 2018

(54) ULTRA-HIGH STRENGTH HOT-PRESSED GEOPOLYMERIC COMPOSITION AND PRODUCTION METHOD THEREOF

(71) Applicant: Navid Ranjbar, Shiraz (IR)

(72) Inventor: Navid Ranjbar, Shiraz (IR)

(21) Appl. No.: 15/964,734

(22) Filed: Apr. 27, 2018

Related U.S. Application Data
(60) Provisional application No. 62/509,767, filed on May 23, 2017.

(51) Int. Cl. C04B 12/00; C04B 14/06; C04B 14/10; C04B 14/24; C04B 14/34; C04B 18/04; C04B 20/00; C04B 22/06; C04B 41/00; B28B 3/02; B28B 7/00

(52) U.S. Cl. CPC C04B 12/005; C04B 14/06; C04B 14/108; C04B 14/24; C04B 14/34; B28B 7/0008; C04B 20/0056; C04B 22/062; C04B 41/0081; B28B 3/025; C04B 18/0481

(57) ABSTRACT

A hot-pressed geopolymeric composition and producing method for making the ultra-high strength geopolymer are disclosed. The hot-pressed geopolymeric composition may include at least one aluminosilicate source and at least one alkali activator and optionally any kind of fillers. The ultra-high strength geopolymer with various densities can be produced by applying low hot-pressing pressure in a short time.

### CROSS REFERENCE TO RELATED APPLICATION

The present invention application claims priority from pending U.S. Provisional Patent Application Ser. No. 62/509,767, filed on May 23, 2017, entitled “HOT-PRESSED GEOPOLYMERS”, which is incorporated by reference herein in its entirety.

### SPONSORSHIP STATEMENT

This application has been sponsored by the Iranian Nanotechnology Initiative Council, which does not have any rights in this application.

### TECHNICAL FIELD

The present disclosure generally relates to hot-pressed geopolymers, and more particularly to a hot-pressed, low-density geopolymer and production method thereof.

### BACKGROUND

Geopolymers are aluminosilicate polymers that consist of amorphous and three-dimensional structures formed by geopolymerization of aluminosilicate monomers in the presence of an alkaline solution. Geopolymers are considered as alternatives to portland cement because of certain desirable properties, such as low carbon dioxide release, high early strength, chemical stability, etc. However, properties of geopolymers can be highly dependent on casting curing conditions, such as moisture, temperature, pressure, etc.

Curing geopolymers at ambient temperatures in a range of 20-30° C. can result in gradual filling of some pore fractions of the materials and thus forming a dense matrix. However, curing geopolymers applying low temperature can require high pressure, long curing time, or complex mold. Increase in curing temperature affects the kinetics of fly ash based geopolymerization significantly, because high temperature increased both dissolution and polycondensation rates, resulting in a fast setting of the material. Fast setting, though, can lead to an increase in the pore volume and can prevent the mixture from forming a compact structure. This can lead to a decrease in the ultimate compressive strength of the geopolymer. Although this reduction in ultimate strength is not favored, the high early strength at elevated temperatures makes the geopolymers suitable for conventional construction purposes.

Hence, it is desired to find a method for producing an integrated high strength and ultra-fast hardened geopolymer with already available equipment, in a short production time.

### SUMMARY

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In one general aspect, the present disclosure describes an ultra-high strength hot-pressed geopolymeric composition including at least one aluminosilicate source and at least one alkali activator. The above general aspect may include one or more of the following features.

In some implementations, the aluminosilicate source can be selected from the group consisting of fly ash, kaolin, metakaolin, palm ash, volcanic ash, rice husk ash, granite waste, silica fume, micro silica, any types of slag, natural pozzolans, silica, alumina, vitrified calcium aluminosilicate, ground recycled glass pozzolans, pulverized fuel ash, bottom ash, sugar cane bagasse ash, clays, natural aluminosilicate, synthetic aluminosilicate glass powder, zeolite, scoria, allophone, bentonite, pumice, or any mixture thereof.

In some implementations, the alkali activator can be selected from the group consisting of hydroxides of alkali metals, silicates of alkali metals, anhydrous borax or any mixture thereof.

In some implementations, the ultra-high strength hot-pressed geopolymeric composition is characterized as a low-density geopolymer, having a compressive strength more than 130 MPa.

In some cases, the compressive strength of the ultra-high strength hot-pressed geopolymeric composition is improved by more than 30% over 100 days.

In some implementations, the density of the ultra-high strength hot-pressed geopolymeric composition is less than 1380 kg/m³.

In a general aspect, the present disclosure is also directed to a method for producing an ultra-high hot-pressed geopolymeric composition.

An implementation may include mixing at least one aluminosilicate source with at least one alkali activator in a ratio of 1-50 wt %, in any mixing order, to form a mixture; pouring the mixture into a mold; fast hardening the mixture at a desired pressure and temperature under a steam-venting condition for about 2-60 minutes to form a hot hardened material, wherein the pressure and temperature can be applied in any order; and cooling the hot hardened material to produce the hot-pressed geopolymeric composition with a compressive strength of more than 100 MPa.

In some cases, the mixture further includes at least one filler, which can be selected from the group consisting of sand, vermiculite, expanded glass, expanded shale, fibers, hollow fibers, particles, rods, wires, volcanic cinders, glass bubbles, aluminum bubbles, manmade and/or coal combustion by-product cenospheres, synthetic or protein air voids, other manmade or naturally occurring and void creating materials, or any mixture thereof.

In some implementations, the mixture can be poured into the mold without any pretreatment.

In some implementations, the mold used in the fast hardening step can have a simple designation with any geometry.

In some implementations, the mold used in the fast hardening step can include a cylinder/tube and piston/pistons with a liquid/steam vent.

In some cases, the pressure and temperature in the fast hardening step can be applied simultaneously. Alternatively, in some cases the pressure and temperature in the fast hardening step can be applied non-simultaneously.

In some implementations, the desired pressure in the fast hardening step can be in a range of 5-100 MPa, and such pressure can be induced by any pressing method, including but not limited to, hydraulic, pneumatic, or mechanical pressing.

In some implementations, the desired temperature in the fast hardening step can be in a range of 50-500° C., and that temperature can be applied by any heating method, including but not limited to, electrical heating, fuel burning, or microwave heating.

Additional systems, methods, features, and advantages of the implementations will be or will become apparent to one of ordinary skill in the art upon examination of the following figures and detailed description. It is intended that all such additional systems, methods, features, and advantages be included within this description and this summary, and be within the scope of the implementations and be protected by the following claims.

### BRIEF DESCRIPTION OF THE DRAWINGS

FIG. 1A illustrates a cross-sectional image of a simple hot-pressing mold.

FIG. 1B illustrates a cross-sectional image of a simple hot-pressing mold equipped with a heating source from sidewalls.

FIG. 1C illustrates a cross-sectional image of a simple hot-pressing mold equipped with a heating source from top side.

FIG. 1D illustrates a cross-sectional image of a simple hot-pressing mold equipped with a heating source from bottom side.

FIG. 1E illustrates a cross-sectional image of a simple hot-pressing mold equipped with a heating source from both top and bottom sides.

FIG. 2 illustrates a geopolymerization mechanism in a hot-pressing method.

FIG. 3 illustrates a Fourier transform infrared spectroscopy (FTIR) spectra of an implementation of the fly ash (FA), the normal geopolymer, and the hot-pressed geopolymers prepared by different concentration of the alkali activator.

FIG. 4 illustrates an X-ray diffraction (XRD) pattern of an implementation of the fly ash (FA), the hot-pressed geopolymer, and the normal geopolymer.

FIG. 5 illustrates an X-ray diffraction (XRD) pattern of an implementation of the volcanic ash (VA) and the hot-pressed geopolymers cured at different temperatures (110-400° C.) and durations (10-40 min).

FIG. 6A illustrates a FESEM image of an implementation of a hot-pressed geopolymer with an initial applied pressure of 13.8 MPa.

FIG. 6B illustrates a FESEM image of an implementation of a hot-pressed geopolymer with an initial applied pressure of 41.4 MPa.

FIG. 6C illustrates a FESEM image of an implementation of a pore structure of the FA-based geopolymer.

FIG. 6D illustrates a phase fraction variation of an implementation of a hot-pressed geopolymer with the different initial applied pressures.

FIG. 7A illustrates the SEM image of the VA-based hot-pressed geopolymers cured for 30 min at 110° C.

FIG. 7B illustrates the SEM image of the VA-based hot-pressed geopolymers cured for 30 min at 400° C.

FIG. 8 illustrates effect of the hot-pressing method on the compressive strength and the density of an implementation of the FA-based hot-pressed geopolymer.

FIG. 9 illustrates the influence of sodium concentration on the compressive strength of an implementation of the FA-based hot-pressed geopolymer.

FIG. 10 illustrates the influence of alkali activator/FA ratio on the compressive strength of an implementation of the FA-based hot-pressed geopolymer

FIG. 11 illustrates the compressive strength of an implementation of the FA-based hot-pressed geopolymer over time.

FIG. 12 illustrates the thermal gravimetric analysis (TGA) curves of an implementation of the VA-based hot-pressed geopolymers cured at different conditions.

FIG. 13A illustrates the compressive strength of the VA-based hot-pressed geopolymers cured at different pressures and temperatures.

FIG. 13B illustrates the compressive strength of the VA-based hot-pressed geopolymers cured at different temperatures and durations.

FIG. 13C illustrates the density of the VA-based hot-pressed geopolymers cured at different pressures and temperatures.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings. The following detailed description is, therefore, not to be taken in a limiting sense, and the scope of the present invention is defined only by the appended claims.

Features of compositions and methods according to the present application is to reduce the pore fractions of a geopolymeric composition and accelerate the hardening rate via a hot-pressing method for producing an ultra-high strength geopolymeric composition with a wide range of density, particularly production of a low-density and ultra-high strength geopolymeric composition. Some benefits from these features may include, but are not limited to, producing an ultra-high strength geopolymeric composition with an improved long-term compressive strength and a low brittleness index.

Applying a low pressure for the hardening step without any material pretreatment is another advantage of the present application for producing the ultra-high strength geopolymer.

In addition, due to the possibility of steam exhaust during the process, a mold with a simple designation and any geometry can be used in this method, which is another advantage of the present application.

Uses of product according to this disclosure can include, for example, construction materials in precast constructions, breaks, and ceramics; and these utilize features and advantages such as fast setting and high strength. Furthermore, product according to this disclosure can provide high thermal stability and is useful for fireproofing in refractories and constructions. Also, the instant product can be used where low liquid penetration is required such as in sewage pipes and liquid containers owing to the pore-less structure of the product.

Aspects and features in an exemplary production of a geopolymeric composition with an aluminosilicate source and an alkali activator in a hot-pressing method at low pressure, in a short time, as well as, without any pretreatment using a mold with steam exhaust will be described in greater detail. Physical and mechanical properties of the geopolymeric composition are evaluated, and described in more detail in connection with specific implementations of the present application.

### Producing an Ultra-High Strength Geopolymeric Composition

One implementation of a method of producing an ultra-high strength geopolymeric composition according to the present disclosure is as follows: First, an alkali activator is prepared by either hydroxide or silicate of alkali metals or borax solution, or a mixture of them. Then, at least one above-described alkali activator and at least one aluminosilicate source are mixed to a fresh mixture, which is then poured into a hot-pressing mold. In an aspect, the pouring can be performed without any pretreatment of the fresh mixture. Next, the poured mixture in the hot-pressing mold is subjected to an appropriate pressure and temperature at different processing durations to remove air bubbles and accelerate the hardening process. In one implementation, the hardening condition may be in a range of 5-100 MPa and 50-500° C. for 2-60 min. The hot hardened material is gradually cooled. That time duration is only an example, as in some implementations, time duration for heating, hot-pressing, and cooling can vary.

The pressure and temperature in the hardening process can be applied simultaneously or non-simultaneously. In one implementation, the ultra-high strength geopolymeric composition may be produced in the following sequence: cold-pressing, then hot-pressing, followed by removing the heat, and removing the pressure. In another implementation, the ultra-high strength geopolymeric composition may be produced in the following sequence: cold-pressing, then removing the press, followed by heating, and then removing the heat.

In one implementation, the aluminosilicate source may include low/high calcium fly ash, kaolin, metakaolin, palm ash, volcanic ash, rice husk ash, granite waste, silica fume, micro silica, any types of slag, natural pozzolans, silica, alumina, vitrified calcium aluminosilicate, ground recycled glass pozzolans, pulverized fuel ash, bottom ash, sugar cane bagasse ash, clays, natural aluminosilicate, synthetic aluminosilicate glass powder, zeolite, scoria, allophone, bentonite, pumice, or any mixture thereof.

In some implementations, the fresh mixture can include lightweight or heavyweight fillers such as, but not limited to, sand, vermiculite, expanded glass, expanded shale, fibers, hollow fibers, particles, rods, wires, volcanic cinders, glass bubbles, aluminum bubbles, manmade and/or coal combustion by-product cenospheres, synthetic or protein air voids, other manmade or naturally occurring and void creating materials, or any mixture thereof.

As used herein, the term “pretreatment” refers to any treatment, including, for example, a thermal treatment, a mechanical treatment, aging, or any combination thereof. In one implementation, the thermal treatment can include an electrical heating, a fuel burning heating, or a microwave heating. In another implementation, the mechanical treatment may include grinding, pulverizing, milling, granulating, or screening. In other implementations, aging can include keeping the mixture at desired condition for a specific period of time before pouring into the mold.

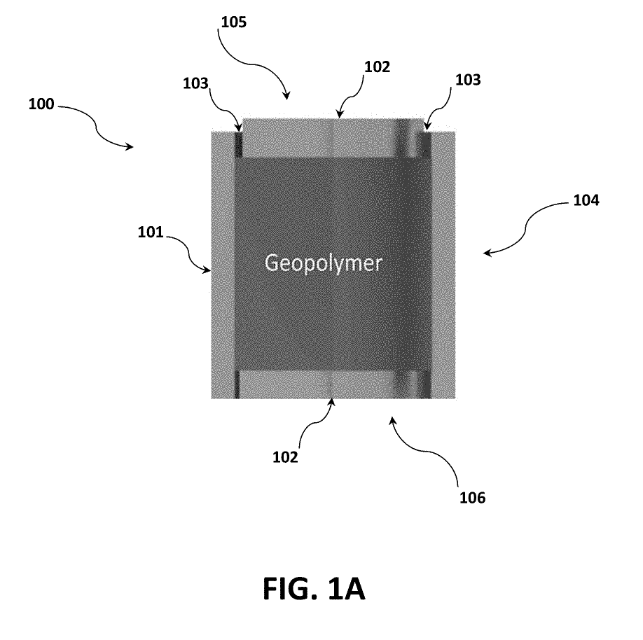

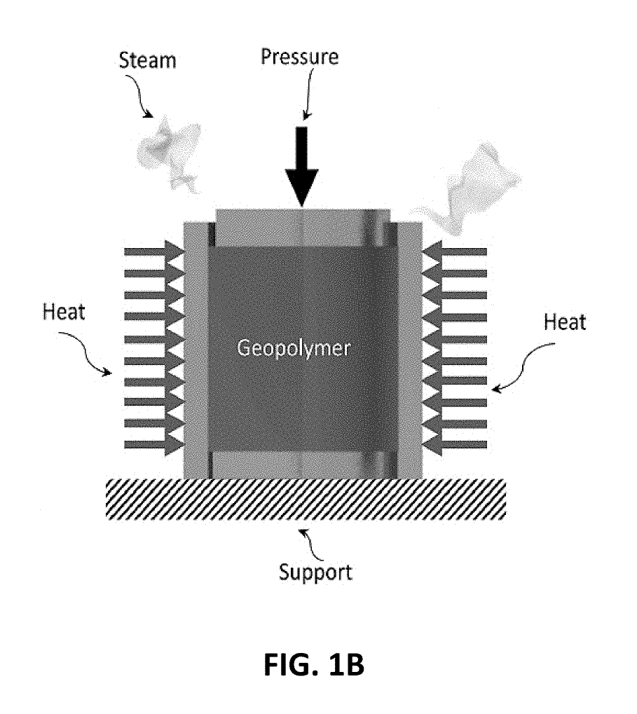

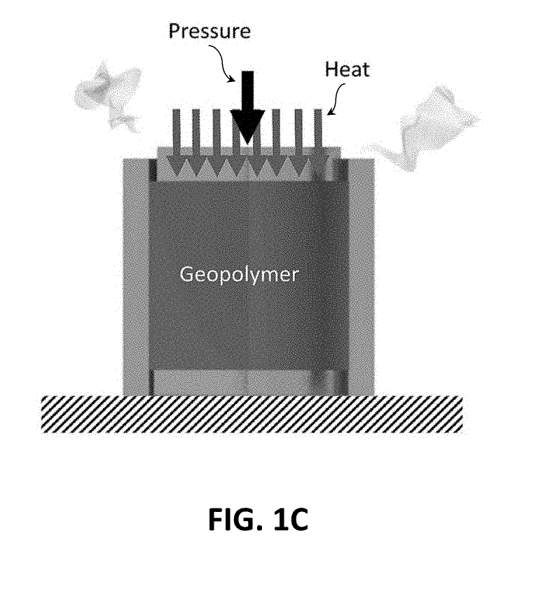

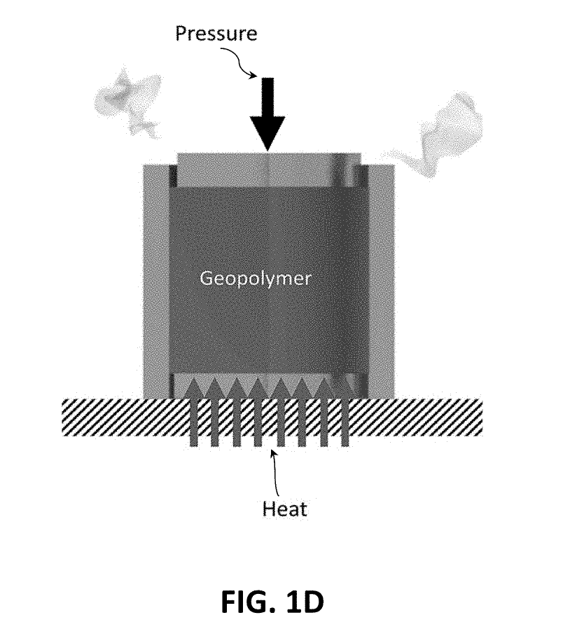

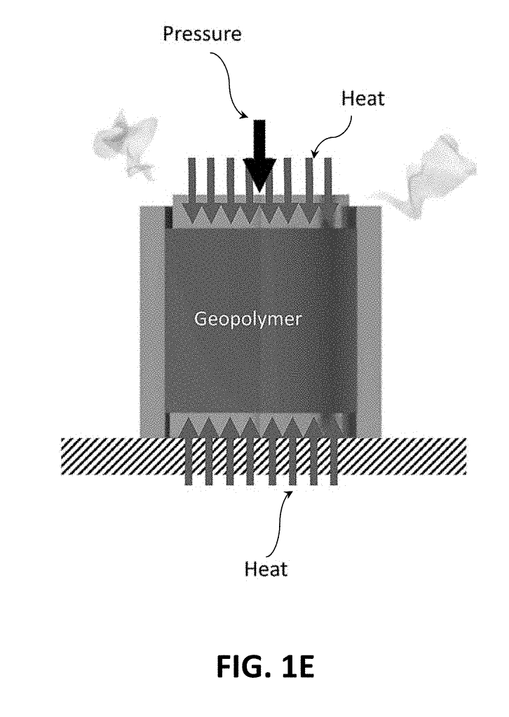

FIGS. 1A-1E illustrate a cross-sectional images of a simple exemplary hot-pressing mold 100 equipped with a heating source. In one implementation, as shown in FIG. 1A, the mold 100 has two parts, including a cylinder/tube 101 and piston/pistons 102 with the possibility of the extra liquid/steam fraction exhaust through a gap 103 between these parts. In an implementation, as shown in FIGS. 1B-1E, the hot-pressing mold 100 is equipped with a heating source. In an aspect, the heating source can be supplied from a side wall 104 of the cylinder/tube 101, top/bottom sides 105/106, both top side 105 and bottom side 106, or any combination thereof. According to one or more implementations, the heating source can be selected as electrical, fuel burning, or a microwave heating method. In some implementations, the heating source can be embedded in the cylinder 101/piston 102 or applied on the external surface of the cylinder 101/piston 102. In the hot-pressing method, the mold 100 can have a simple design and there is no need for complex techniques for keeping the water for hydration (i.e. water retreatment), so it is more practical for industrial applications. Having no need for water retreatment can be beneficial, because retreatment of water can make the mold design difficult and can increase the possibility of rusting. In one implementation, any workable material under the hot-pressing condition can be used as a mold material, including, but not limited to, steel and acrylic.

### Geopolymerization Mechanism in a Hot-Pressing Method

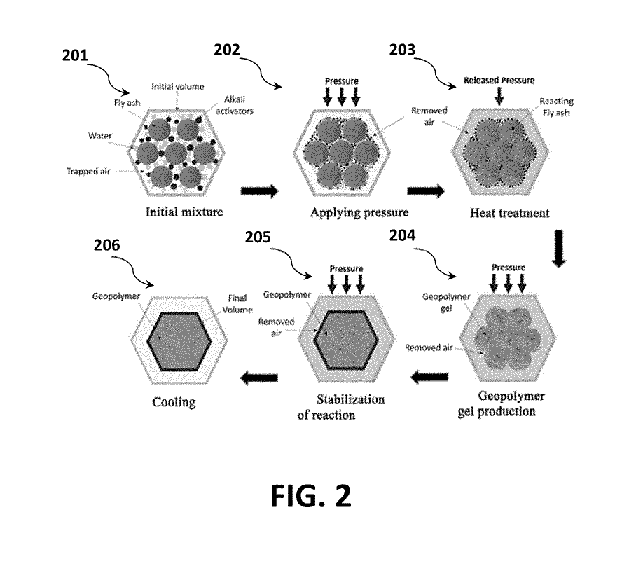

FIG. 2 illustrates a geopolymerization mechanism in a hot-pressing method. In a step 201 of the FIG. 2, in one implementation, a mixture of at least one aluminosilicate source, at least one alkali activator, and optionally at least one lightweight or heavyweight filler is poured into a mold.

The appearance of the fresh mixture poured in the mold is quite similar to a wet ash with a large volume of trapped air. In a step 202, a pressure is applied to remove the unwanted large volume of the trapped air for producing a condensed matrix.

In a step 203, the condensed matrix is subjected to a temperature for accelerating a geopolymer gel formation. During the heat treatment, the geopolymerization may be divided into approximately three aspects or steps, including extra water expulsion, dissolution-hydrolysis, and hydrolysis-polycondensation. In one implementation, these three aspects or steps may occur simultaneously during the heat treatment. Increasing the temperature of the condensed matrix can lead to an increase in the pressure in the hot-pressing mold. In addition, a decrement in a liquid phase viscosity can occur during the hot-pressing process. Consequently, the liquid phase distributes homogeneously through the matrix in a short period of time, resulting in the release of aluminate and silicate monomers by alkali attack on solid aluminosilicate source, which is accelerated significantly with temperature increment. The extra liquid is forced out by the high pressure in the hot-pressing mold. This liquid is mostly comprised of water, in the form of steam, since it has a lower boiling temperature compared with that of the alkali activator. The water expulsion causes a reduction in volume and consequently a pressure loss in step 203.

In a step 204, the pressure is enhanced continuously to the initial level to keep the pressure constant during the pressing. As a consequence of the hot-pressing process, the conversion of solid particles to the geopolymer gel is accelerated by the formation of dissolved species that are cross-linked to form oligomers, which in turn produces a sodium silicoaluminate gel. Referring again to step 204, removing the air that is trapped within the spherical particles can cause a reduction in the volume and further pressure loss.

Subsequent pressure increase to initial condition results in a condensed matrix with a proper shape of the mold in a step 205. During step 205, thermodynamic stability is reached and, due to the polycondensation and formation of a three-dimensional aluminosilicate network under the hot-pressing condition, the matrix is hardened, therefore, no more pressure loss is observed.

Subsequently, in a step 206, the hardened matrix is cooled under the initial pressing condition and finally, and the pressure is removed to obtain a cooled geopolymer.

Briefly, frequent loss and rise of the pressure that arises from applying steam-venting condition in the present hot-pressing method can affect both microstructural and physical properties of the hardened matrix. Therefore, an ultra-high strength geopolymeric composition with a wide range of density and more particularly with low-density can be produced by the present hot-pressing method.

### Example 1: Producing a Fly Ash-Based Geopolymeric Composition by a Hot-Pressing Method

In Example 1, a geopolymeric composition was produced pursuant to the teachings of the present disclosure. In this case, the geopolymeric composition is composed of a low calcium (class F) fly ash (FA) as an aluminosilicate source and a combination of a sodium silicate and a sodium hydroxide as an alkali activator.

### Raw Materials Specification

A mixture of sodium silicate and sodium hydroxide were prepared with a mass ratio of about 2.5:1.0 to activate the aluminosilicate particles. The sodium silicate was used in liquid form with about 1.5 g of water per milliliter at 20° C. with a SiO₂/Na₂O mass ratio of about 2.5. The chemical composition of FA is presented in TABLE 1. The median average particle size and specific gravity of the FA were indicated as about 12.19 μm and about 2.18, respectively.

TABLE 1
The chemical composition of FA

| | Composition | | | | | | | | | | | | |
|---|---|---|---|---|---|---|---|---|---|---|---|---|---|
| | SiO₂ | Al₂O₃ | Fe₂O₃ | K₂O | TiO₂ | CaO | SO₃ | MgO | P₂O₅ | Na₂O | ZrO₂ | MnO | LOI |
| wt (%) | 75.76 | 15.86 | 3.90 | 1.14 | 0.97 | 0.95 | 0.35 | 0.26 | 0.21 | 0.16 | 0.13 | 0.06 | 6.8 |

### FA-Based Geopolymeric Composition Preparation

For producing a geopolymeric composition, an alkali activator (a sodium hydroxide concentration of about 8 molar (M)) and FA were mixed with an alkali activator/FA mass ratio of about 0.35 for approximately 5 min. Then the mixture was poured into a steel pressing mold and was subjected to a desired temperature and pressure for a hot-pressing duration of about 20 min. The heating temperature and the induced pressure were set at about 350° C. and about 34.5 MPa, respectively. Following the hot-pressing treatment, the heater was removed and the mold was cooled down by a cooler in approximately 10 min. Finally, the produced geopolymeric composition was removed and kept in an ambient temperature in a range of 20-30° C.

### Characterization of the FA-Based Geopolymeric Composition

The impact of induced pressure, hot-pressing duration, alkali activator/FA mass ratio and sodium concentration on the compressive strength and microstructural features of the hot-pressed FA-based geopolymeric composition was assessed.

To evaluate the hot-pressing method, the characteristics of the hot-pressed geopolymeric composition were compared with those of the corresponding geopolymeric composition prepared by the same materials and by employing a conventional curing method (normal geopolymer). The normal geopolymer was prepared by the following steps: mixing an alkali activator and FA as an aluminosilicate source with an alkali activator/FA mass ratio of about 0.5, pouring the mixture into a steel mold, sealing by a cling film, curing at 65° C. in an oven for 24 hours, removing the cured product from the mold, and maintaining the final product at ambient temperature in a range of 20-30° C. Unlike the present hot-pressing method, some amount of water was added in the conventional curing method to reach a final alkali activator mass ratio of sodium silicate:sodium hydroxide:water of about 2.5:1.0:0.7. The amount of alkali activator for producing normal geopolymers is about twice of that used for producing the ultra-high strength hot-pressed geopolymeric compositions using the present hot-pressing method.

### Example 2: Producing a Volcanic Ash-Based Geopolymeric Composition by a Hot-Pressing Method

In Example 2, a geopolymeric composition was produced pursuant to the teachings of the present disclosure. In this case, the geopolymeric composition is composed of a volcanic ash (VA) as an aluminosilicate source and a combination of sodium hydroxide and sodium silicate as an alkali activator.

### Raw Materials Specification

A mixture of sodium hydroxide and sodium silicate was prepared with a mass ratio of about 2.5 to activate the aluminosilicate particles. The chemical composition of VA is given in TABLE 2. The average particle size and specific gravity of the VA were determined as about 8.7 μm and about 2.13, respectively.

TABLE 2
The chemical composition of VA

| | Oxide composition | | | | | | | | | | | | | | |
|---|---|---|---|---|---|---|---|---|---|---|---|---|---|---|---|
| | SiO₂ | CaO | Al₂O₃ | Fe₂O₃ | K₂O | Na₂O | MgO | TiO₂ | SrO | SO₃ | P₂O₅ | MnO | BaO | Cl | LOI |
| wt. % | 46.8 | 19.1 | 13.5 | 8.5 | 4.3 | 4.1 | 1.7 | 0.9 | 0.3 | 0.3 | 0.2 | 0.2 | 0.1 | 0.1 | 2.9 |

### Geopolymeric Composition Preparation

For producing a geopolymeric composition, an alkali activator (a sodium hydroxide concentration of about 8 molar) and VA were mixed with an alkali activator/VA mass ratio of about 0.2 for approximately 5 min. Then the mixture was poured into a steel pressing mold and was subjected to a desired temperature and pressure for a hot-pressing duration of 40 min. The heating temperature and the induced pressure were fixed at about 350° C. and 74 MPa, respectively. After the hot-pressing treatment, the heater was removed and the mold was cooled down in approximately 5 min. Ultimately, the produced geopolymeric composition was removed and kept in an ambient temperature in a range 20-30° C.

The influence of alkali activator/aluminosilicate ratio, induced pressure, applied temperature and hot-pressing duration on the compressive strength and microstructural features of the hot-pressed VA-based geopolymeric composition was evaluated.

### Example 3: Characterization Tests

In this example, the results of some characterization tests performed on the geopolymeric composition (prepared as described in detail in connection with Examples 1 and 2) are presented.

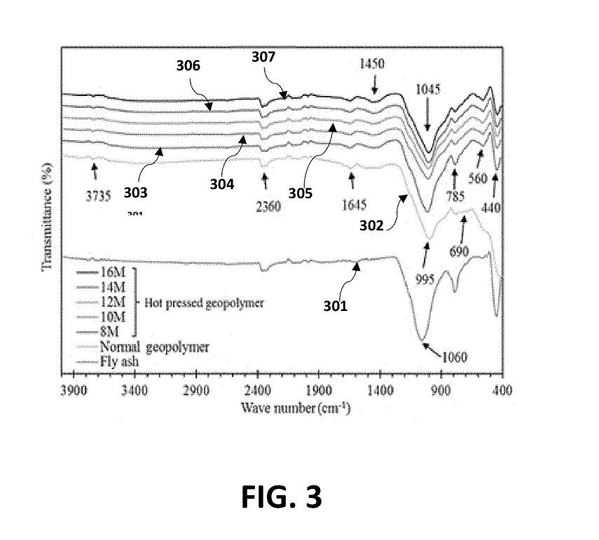

Referring to FIG. 3, Fourier transform infrared (FTIR) spectra of the fly ash (FA) 301, the normal geopolymer 302, and the hot-pressed geopolymers 303-307 prepared by different concentration of the alkali activator are shown. The IR spectra of the geopolymers appear to be similar to that of the FA. This implies that most vibrant forms of the FA molecular chains are retained in the geopolymerization products. The most characteristic difference observed between the FTIR spectra of the FA and that of the normal geopolymer is associated with the broadband at about 1060 cm⁻¹ (asymmetric stretching vibrations of Si—O—Si and Al—O—Si bonds) which is shifted to lower frequencies of about 995 cm⁻¹ in the spectrum of the normal geopolymer. This shift can be associated to dissolution of the FA amorphous phase in the alkali activator and formation of the amorphous aluminosilicate gel phase. However, this band is returned to a higher frequency, at 1045 cm⁻¹ in the FTIR spectra of the hot-pressed geopolymers. Unlike the normal geopolymer, another observable structural reorganization of the FA is realized in the hot-pressed geopolymers by reduction of the absorption band at about 790 cm⁻¹ (AlO₄ vibrations) and the appearance of a new band at 560 cm⁻¹ that can be assigned to the symmetric stretching vibrations of Al—O—Si which is related to the formation of semi-crystalline products from the amorphous aluminosilicate.

Additionally, the presence of a band at about 2300 cm⁻¹ in the spectrum of the FA, normal geopolymer, or hot-pressed geopolymers can be attributed to stretching vibration of —OH and H—O—H due to the existence of weak H₂O bonds that are absorbed on the surface or trapped among the particles. Furthermore, new bands appeared at 1645 cm⁻¹ and 3735 cm⁻¹ in all the geopolymers can be ascribed to H—O—H bending vibration and —OH stretching vibration. Furthermore, all the geopolymers demonstrate the stretching vibration of O—C—O band at 1410-1500 cm⁻¹ of the infrared spectrum that can indicate the presence of sodium carbonate in the geopolymers.

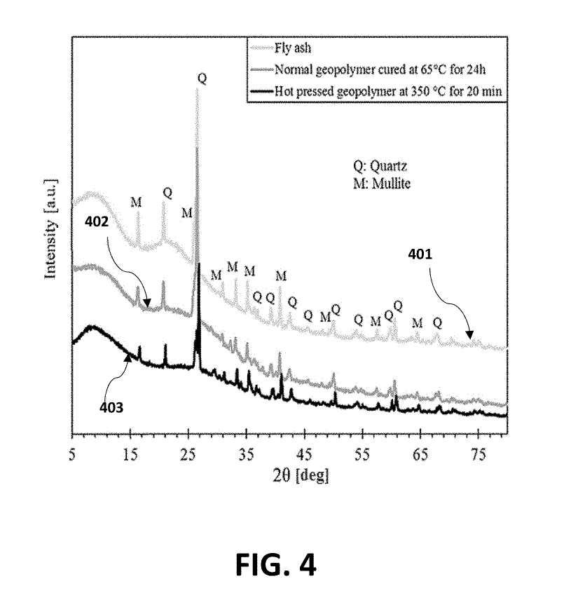

Referring next to FIG. 4, an X-ray diffraction (XRD) pattern of the fly ash (FA) 401, the hot-pressed geopolymer 402, and the normal geopolymer 403 is shown. The XRD patterns in FIG. 4 show that irrespective of the curing method, geopolymers have both an amorphous and semi-crystalline structure containing crystalline phases of quartz and mullite originating from undissolvable FA particles. The broad hump which is located between 2θ=17° and 35° in the patterns may be as a result of diffuse scattering of the amorphous material. This hump can be in connection with the glassy phases in the FA pattern 401. While in the XRD pattern of the geopolymers 402 and 403, the similar hump may represent the remaining glassy portion of the unreacted particles that are partially overlapped with the sodium aluminosilicate. The amorphous aluminosilicates are produced through the following steps including the formation of tetrahedral aluminosilicate units via dissolution of the FA particles by the alkali activators, formation of monomers and oligomers through self-polymerization of tetrahedral aluminosilicate units and finally polymerization between silicate oligomers and/or between AlO₄⁻ and silicate oligomers. The amorphous aluminosilicate is comprised of tetrahedral aluminosilicate units (formed via dissolution of the FA particles by the alkali activators), self-polymerizing species such as monomers and oligomers (produced when the soluble silicate catalysis the polymerization), and polymerization between silicate oligomers and/or between AlO₄⁻ and silicate oligomers.

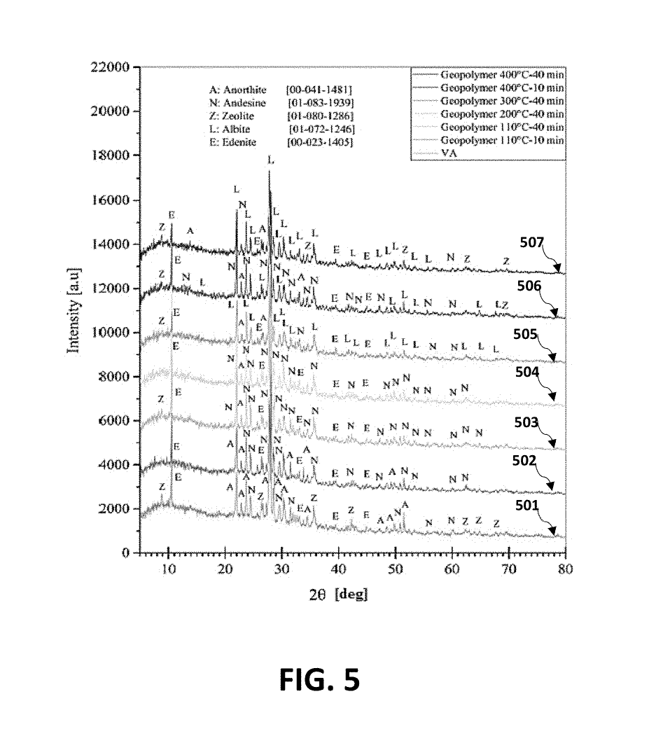

Referring now to FIG. 5, an X-ray diffraction (XRD) pattern of the volcanic ash (VA) 501 and the hot-pressed geopolymers 502-507 cured at different temperatures (110-400° C.) and durations (10-40 min) are shown. The XRD pattern 501 in FIG. 5 represents the amorphous phase associated with the rapid cooling of the volcanic lavas. The intact VA contains large amounts of plagioclase compositions, mainly anorthite, and trace levels of other compositions of zeolite and edenite. The plagioclase series is a group of related feldspar minerals with similar formula but differing in sodium and calcium percentages. As the VA is mixed with an alkali activator, its chemical composition is expected to change as the sodium concentration is increased in a semi-aqueous system. The dominant composition of the VA-based hot-pressed geopolymers consists of an amorphous to semi-crystalline glassy structure, in addition to the crystalline phases of andesine and albite. As shown in the XRD patterns 502-507 in FIG. 5, formation of these fractions in the hot-pressed geopolymers is a function of the applied curing temperature, pressure, and duration. Moreover, formation of albite phase is time dependent and more probable at longer durations. In addition, formation of the andesine phase can be more likely under either low temperature or low curing time as presented in the XRD patterns 502-504.

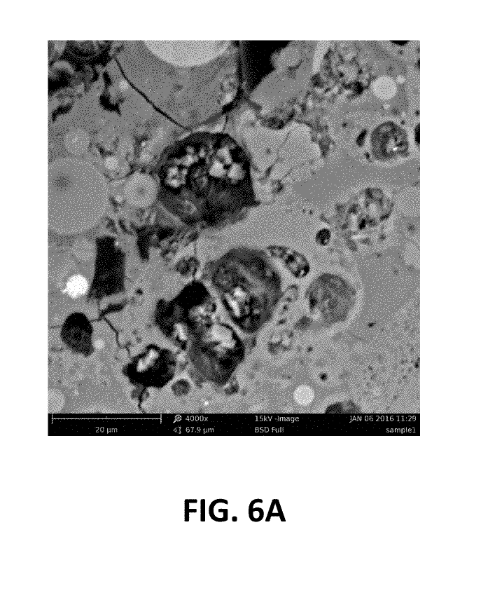

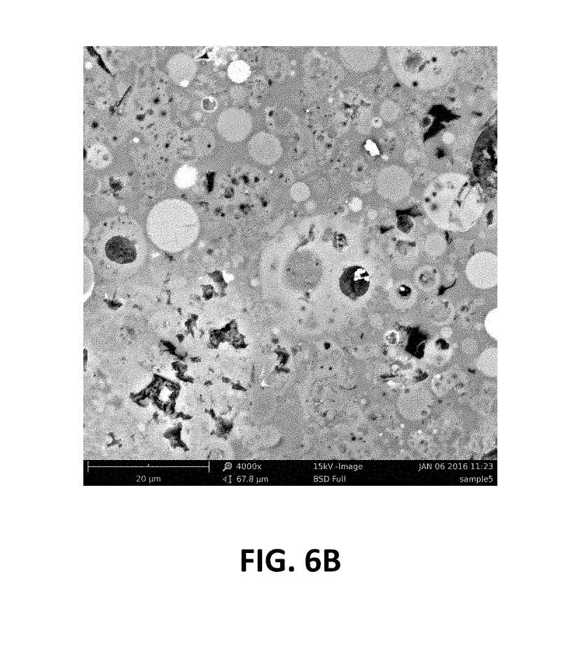

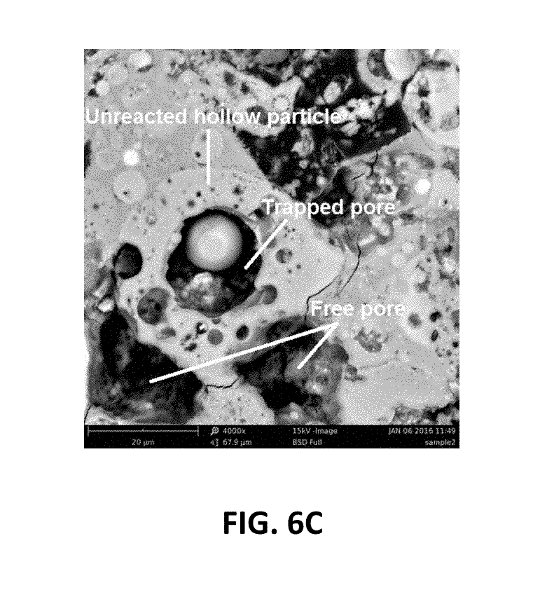

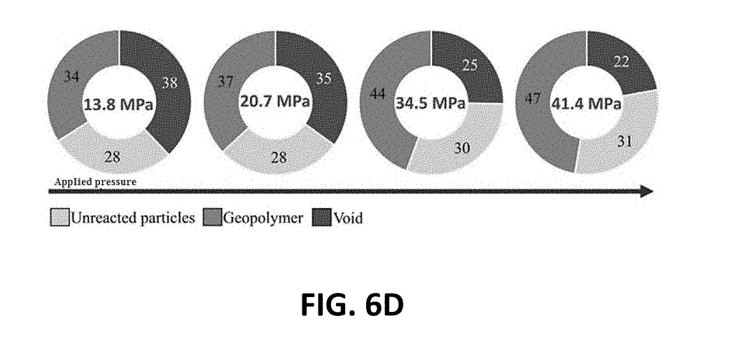

In FIGS. 6A-6D, a series of field emission scanning electron microscopy (FESEM) images of the hot-pressed geopolymer with an initial applied pressure of 13.8 MPa (FIG. 6A) and 41.4 MPa (FIG. 6B) along with a pore structure of the FA-based geopolymer (FIG. 6C) and a phase fraction variation of the hot-pressed geopolymer with the different initial applied pressure (FIG. 6D) are presented.

FIG. 6A and FIG. 6B, indicate a readily visible reduction in pore size and pore volume of the hot-pressed geopolymers when subjected to a pressure of 41.4 MPa compared with 13.8 MPa pressure. As observed in FIG. 6C, some portion of the pore volume is incompressible due to the unreactive hollow particles (trapped pore) while the other portion (free pore) is removable when the fresh geopolymer is subjected to a higher pressure.

The images were processed using multispectral analysis to do a supervised classification of pores and geopolymer mixture made on MultiSpec© (Purdue Research Foundation). The multispectral images were analyzed by imageJ software to quantify the pore, geopolymer gel, and unreacted particle fractions

As shown in FIG. 6D, a quantitative measurement of different volume fractions (including unreacted particles, pores and geopolymer solid phases) was applied by multispectral analysis of several high resolution SEM images based on the known microstructural features of the FA particles and the FA-based hot-pressed geopolymer. Enhancement of the applied pressure may lead to a reduction of the pore volume, as well as, an increase in the hot-pressed geopolymer/unreacted particle ratio. In other words, the increased strength of the hot-pressed geopolymer at higher applied pressures may be attributed not only to the dense structure of the geopolymer but also to the higher geopolymer gel formation.

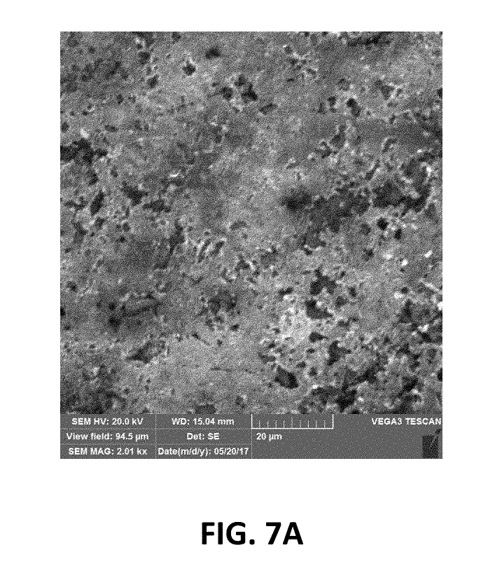

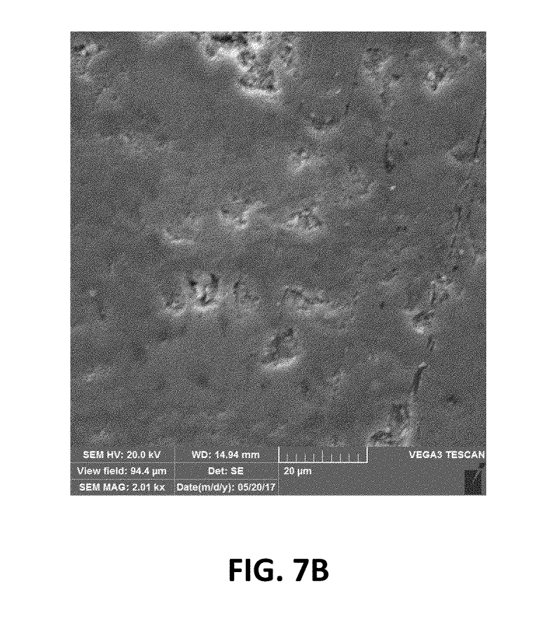

In FIGS. 7A and 7B, a series of scanning electron microscopy (SEM) images are presented. The SEM images of the VA-based hot-pressed geopolymers cured for 30 min at 110° C. and 400° C. are illustrated.

### Example 4: Evaluation of Mechanical, Thermal and Physical Properties

In this example, the results of some mechanical, thermal and physical tests performed on the geopolymeric composition (prepared as described in detail in connection with Examples 1 and 2) are presented.

Elastic modulus, microhardness, fracture toughness, and brittleness index of the produced geopolymeric composition at different initial pressures were determined and the results are presented in TABLE 3. As shown in TABLE 3 below, the results demonstrate that the microhardness, elastic modulus and fracture toughness are highly relevant to the initial applied pressure and the consequent porous structure of the material, as these features of the hot-pressed geopolymer are increased by the initial applied pressure. Increasing the pore volume can alter the failure mechanism to a local layer crashing of the composites under compression due to facilitating the formation of microcracks. Therefore, porous hot-pressed geopolymers may be more prone to the reduction of the fracture toughness and elastic modulus. Brittleness index can be used as a quantitative assessment of the geopolymer machinability as the lower brittleness index results in the higher machinability of the geopolymer. A desirable machinability can occur when the brittleness index of a ceramic material is lower than 4.3 μm^{-0.5}. As shown in TABLE 3, the brittleness index does not follow a particular trend when the geopolymer is subjected to different pressures and it varies between about 1.57 μm^{-0.5} to about 1.7 μm^{-0.5}. The efficiency of the material increases because of such a low brittleness index when the application is optimized based on the cutting energy.

TABLE 3
Influence of initial pressures on elastic modulus, microhardness, fracture
toughness and brittleness index.

| | Elastic | | | Brittleness |
|---|---|---|---|---|
| Pressing | Modulus | Microhardness | Fracture toughness | index |
| (MPa) | (GPa) | (GPa) | (MPa m^{1/2}) | (μm^{-0.5}) |
| 13.8 | 36 ± 4.5 | 1.10 ± 0.05 | 0.70 ± 0.04 | 1.57 |
| 20.7 | 43 ± 4.3 | 1.26 ± 0.08 | 0.74 ± 0.02 | 1.70 |
| 27.6 | 50 ± 3.8 | 1.43 ± 0.04 | 0.90 ± 0.02 | 1.59 |
| 34.5 | 56 ± 3.0 | 1.64 ± 0.05 | 1.04 ± 0.03 | 1.58 |
| 41.4 | 68 ± 3.2 | 1.93 ± 0.08 | 1.15 ± 0.02 | 1.68 |

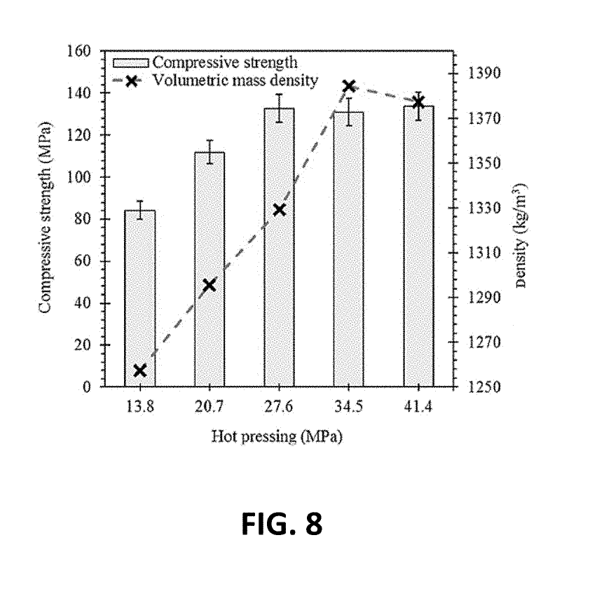

FIG. 8 illustrates the compressive strength and the density of the FA-based hot-pressed geopolymer at various initial pressures for the hot-pressing duration of about 20 minutes. Referring to FIG. 8, by increasing the hot-pressing pressure from 13.8 to 27.6 MPa the compressive strength of the hot-pressed geopolymer was improved from about 84 MPa to about 133 MPa, which can be due to the geopolymer porosity. When the fresh geopolymer mixture is subjected to higher pressures, the air bubbles that are trapped in the matrix are removed resulting in an increase in the density, as well as, a reduction in the pore volume that enhances the geopolymer strength. Referring again to FIG. 8, applying further pressure higher than 27.6, has a minimal effect on the compressive strength improvement since the free pore fraction of the hot-pressed geopolymer can be almost removed when it is subjected to a pressure of 27.6 MPa and it is difficult to remove the remaining pore fractions trapped in hollow spheres. Referring again to FIG. 8, the ultra-high strength FA-based geopolymers are characterized as a low-density geopolymer as the density is less than 1380 kg/m³.

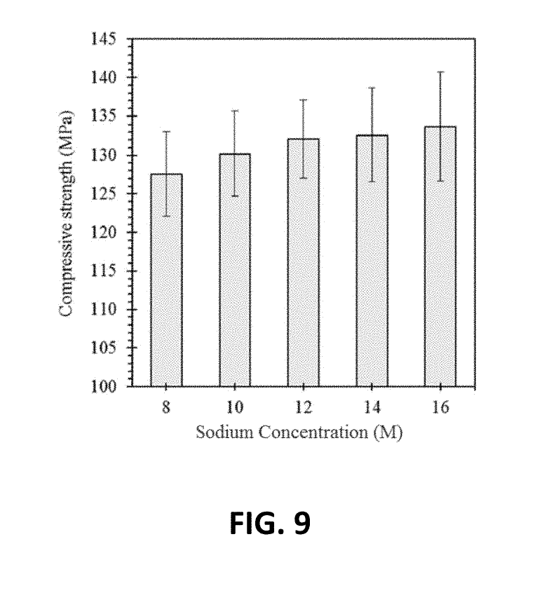

Referring next to FIG. 9, the impact of sodium concentration on the compressive strength of the FA-based hot-pressed geopolymer is shown. FIG. 9 indicates that an increment in the sodium concentration of the mixture from 8 to 16 molar, slightly enhances the mechanical properties of the geopolymer (about 5%). This is ascribed to the higher dissolution of the FA at high OH⁻ concentration of the higher molarities. It should be understood that both the temperature and the pressure have the dominant role in accelerating the geopolymerization process.

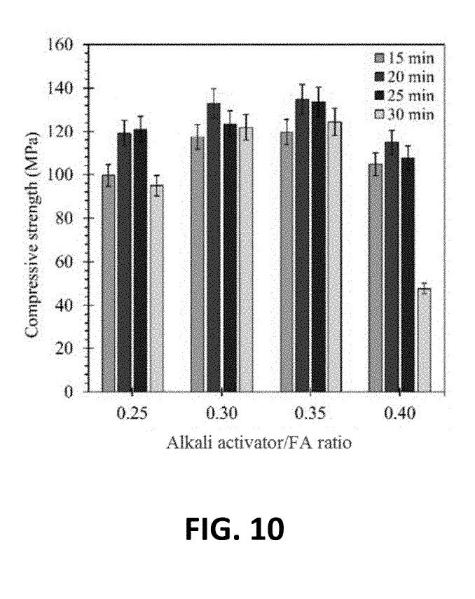

Referring now to FIG. 10, the influence of alkali activator/FA ratio on the compressive strength of the FA-based hot-pressed geopolymer at a constant hot-pressing pressure and temperature of about 41.4 MPa and 350° C., respectively, is demonstrated. FIG. 10 indicates that the hot-pressed geopolymer prepared with the alkali activator/FA ratio of 0.35 has a higher compressive strength at different processing durations. This variation of strength may be attributed to the liquid phase content of the matrix. When the liquid phase content is low, some of the FA particles may remain intact and formation of a uniform geopolymer matrix becomes less possible, as a consequence, the compressive strength of the geopolymer is decreased. When the liquid phase content is high, the liquid phase consisting of the reactive components for geopolymerization may be removed, as a result, the compressive strength of the hot-pressed geopolymer with the alkali activator/FA ratio of 0.4 is reduced.

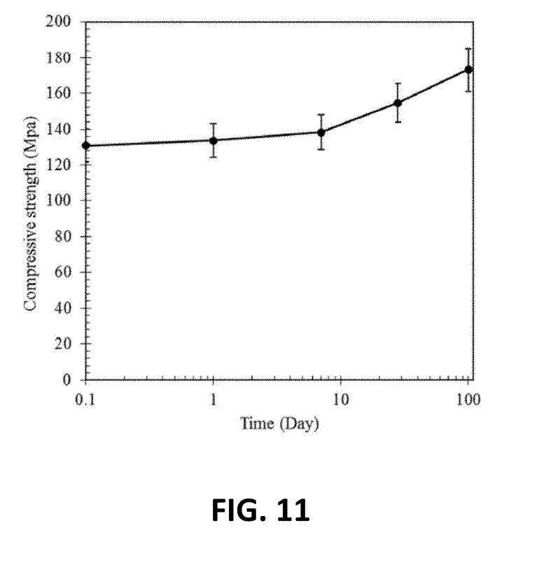

Referring now to FIG. 11, the long-term compressive strength of the hot-pressed geopolymer prepared at 41.4 MPa and 350° C. in 20 min over the period of 100 days is shown. As illustrated in FIG. 11, the compressive strength of the hot-pressed geopolymer is improved by about 30% after 100 days. This time-dependent improvement of the compressive strength may be associated with the slow reaction rate of high silica content particles. This prolonged reaction clogs the pores, leading to the formation of a homogenous matrix with a higher load bearing capacity.

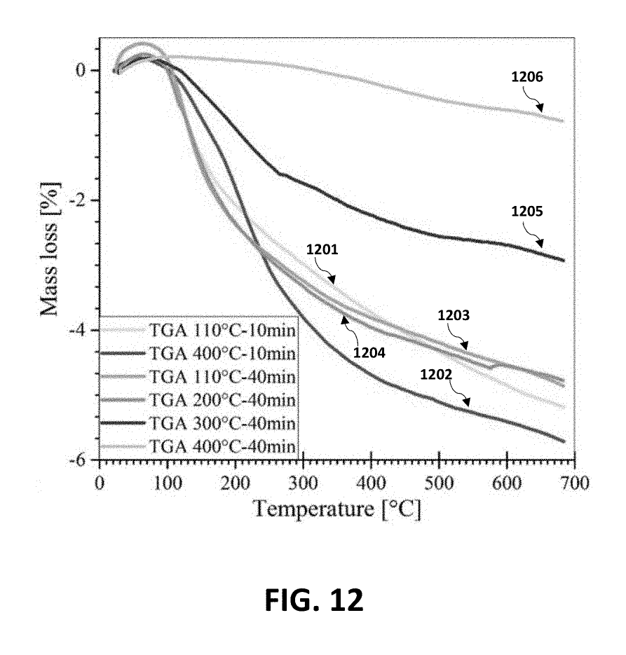

In FIG. 12, Thermal gravimetric analysis (TGA) curves of the VA-based hot-pressed geopolymers cured at different temperatures in the range of 110-400° C. for 10-40 min (as presented in the TGA curves 1201-1206) are illustrated. As shown in FIG. 12, enhancing the curing temperature from 200° C. to 400° C., at a constant curing duration of 40 min, results in a significant decrement in the mass loss of the hot-pressed geopolymer 1204-1206 from about 4.8 wt % to 0.8 wt % at 700° C. In addition, at a constant temperature of either 110° C. or 400° C., mass loss of the hot-pressed geopolymer decreases by increasing the curing duration from 10 to 40 min as presented in the TGA curves 1201-1203 and 1202-1206. Furthermore, the VA-based hot-pressed geopolymer cured at 400° C. for 40 minutes demonstrates a small mass loss of about 0.8 wt % up to 700° C.

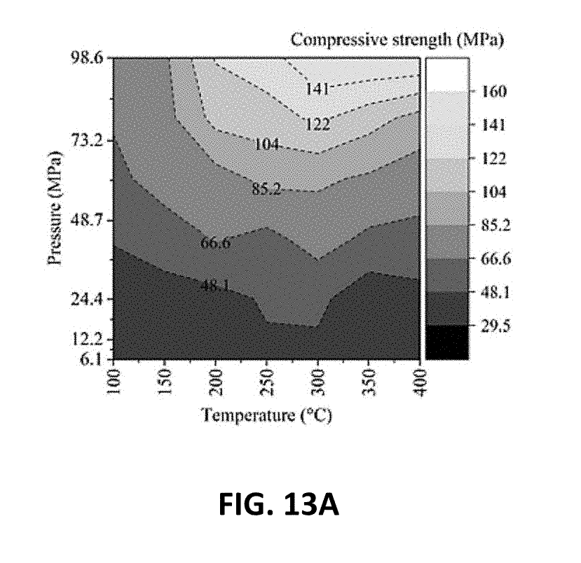

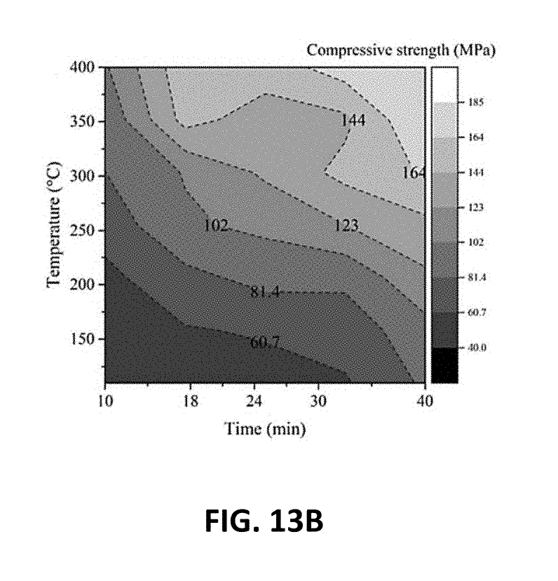

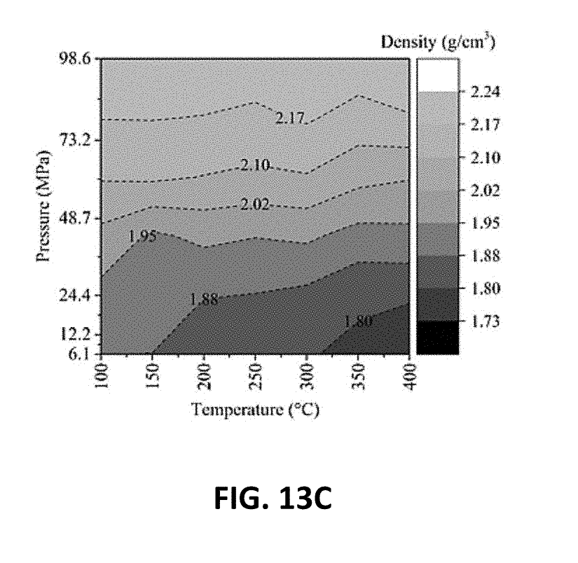

Finally, FIGS. 13A-13C illustrate the physical and mechanical properties of the VA-based hot-pressed geopolymers cured at different pressures, temperatures, and durations. As shown in FIGS. 13A-13C, increasing temperature (100-400° C.), pressure (6.1-98.6 MPa), and curing time (10-40 minutes) contribute to higher mechanical properties. The compressive strength and density of the hot-pressed geopolymer change extensively in a range of 29.5-185 MPa and 1.73-2.24 g/cm³, respectively. As shown in FIG. 13C, by applying a low hot-pressing pressure lower than 100 MPa, the ultra-high strength geopolymers with the density higher than 1.73 g/cm³ can be achieved. As shown in FIGS. 13A-13C, by using volcanic ash as an aluminosilicate source and applying the hardening pressure in the range of 80-100 MPa, the hot-pressed geopolymeric composition with the compressive strength more than 150 MPa and the density more than 2000 kg/m³ is produced.

Overall, the compressive strength of hot-pressed geopolymeric compositions is influenced by pressing force, curing temperature, aluminosilicate source/alkali activator ratio, hot-pressing duration and sodium concentration. Among these parameters, pressure force has the most influence on the compressive strength of the matrix.

Referring again to FIG. 8 and FIG. 13C, using the present hot-pressing method ultra-high strength geopolymeric compositions with a wide range of density including low-density geopolymers (i.e. less than 2000 kg/m³) and normal density geopolymers (i.e. between 2000-3000 kg/m³) can be produced.

What is claimed is:

1. An ultra-high strength hot-pressed geopolymeric composition comprising:
at least one aluminosilicate source; and
at least one alkali activator,
wherein the hot-pressed geopolymeric composition is a low-density geopolymer.

2. An ultra-high strength hot-pressed geopolymeric composition according to claim 1, wherein the at least one aluminosilicate source is selected from the group consisting of fly ash, kaolin, metakaolin, palm ash, volcanic ash, rice husk ash, granite waste, silica fume, micro silica, any types of slag, natural pozzolans, silica, alumina, vitrified calcium aluminosilicate, ground recycled glass pozzolans, pulverized fuel ash, bottom ash, sugar cane bagasse ash, clays, natural aluminosilicate, synthetic aluminosilicate glass powder, zeolite, scoria, allophone, bentonite and pumice, and any mixture thereof.

3. An ultra-high strength hot-pressed geopolymeric composition according to claim 1, wherein the at least one alkali activator is selected from the group consisting of hydroxide of alkali metals, silicates of alkali metals, anhydrous borax and any mixture thereof.

4. An ultra-high strength hot-pressed geopolymeric composition according to claim 1, wherein a compressive strength of said composition is more than 130 MPa.

5. An ultra-high strength hot-pressed geopolymeric composition according to claim 4, wherein the density of said composition is less than 1380 kg/m³.

6. An ultra-high strength hot-pressed geopolymeric composition according to claim 1, wherein the density of said composition is less than 1380 kg/m³.

7. A method for producing an ultra-high strength hot-pressed geopolymeric composition comprising:
a) mixing at least one aluminosilicate source and at least one alkali activator in a ratio of 1-50 wt % in any order to form a mixture,
wherein the at least one aluminosilicate source is selected from the group consisting of fly ash, kaolin, metakaolin, palm ash, volcanic ash, rice husk ash, granite waste, silica fume, micro silica, any types of slag, natural pozzolans, silica, alumina, vitrified calcium aluminosilicate, ground recycled glass pozzolans, pulverized fuel ash, bottom ash, sugar cane bagasse ash, clays, natural aluminosilicate, synthetic aluminosilicate glass powder, zeolite, scoria, allophone, bentonite, and pumice and any mixture thereof, and
wherein the at least one alkali activator is selected from the group consisting of a hydroxide of alkali metals, silicates of alkali metals, and anhydrous borax and any mixture thereof;
b) pouring the mixture of the step (a) into a mold;
c) fast hardening the mixture at a given pressure and temperature, under a steam-venting condition; and
d) producing the ultra-high strength hot-pressed geopolymeric composition with a compressive strength of more than 100 MPa, by cooling the hot hardened material resulting from the step (c).

8. A method according to claim 7, wherein the mixture of step (a) further comprises a filler including sand, vermiculite, expanded glass, expanded shale, fibers, hollow fibers, particles, rods, wires, volcanic cinders, glass bubbles, aluminum bubbles, manmade and/or coal combustion by-product cenospheres, synthetic or protein air voids, other manmade or naturally occurring and void creating materials, or any mixture thereof.

9. A method according to claim 7, wherein pouring the mixture of step (a) into the mold includes pouring without a pretreatment of the mixture.

10. A method according to claim 7, wherein the mold of step (b) has a simple design geometry.

11. A method according to claim 10, wherein the mold of step (b) includes a cylinder/tube and piston/pistons with a liquid/steam vent.

12. A method according to claim 7, wherein the mold of step (b) includes a cylinder/tube and piston/pistons with a liquid/steam vent.

13. A method according to claim 7, wherein the pressure and temperature in step (c) are applied simultaneously.

14. A method according to claim 7, wherein the pressure and temperature in step (c) are applied non-simultaneously.

15. A method according to claim 7, wherein the pressure of step (c) is in a range of 5-100 MPa.

16. A method according to claim 7, wherein the desired temperature of step (c) is in the range of 50-500° C.

17. A method according to claim 7, wherein the fast hardening of step (c) occurs for 2-60 minutes.

18. A method according to claim 7, further comprising: increasing compressive strength by aging over 100 days.
